(19) United States
(12) Patent Application Publication
(10) Pub. No.: US 2014/0206420 A1
(43) Pub. Date: Jul. 24, 2014

(54) WATERPROOF STRUCTURE AND WATERPROOFING METHOD FOR MOBILE TERMINAL DEVICE

(71) Applicant: Shushiro Neichi, Kanagawa (JP)

(72) Inventor: Shushiro Neichi, Kanagawa (JP)

(73) Assignee: NEC CASIO MOBILE COMMUNICATIONS, LTD., Kanagawa (JP)

(21) Appl. No.: 14/240,004

(22) PCT Filed: Aug. 2, 2012
(86) PCT No.: PCT/JP2012/069725

§ 371 Date: Feb. 20, 2014

(30) Foreign Application Priority Data
Aug. 22, 2011 (JP) 2011-180402

(51) Int. Cl. H04B 1/38; H04M 1/02

(52) U.S. Cl. CPC H04B 1/3888; H04M 1/0202
USPC 455/575.8; 277/312

(57) ABSTRACT

Provided is a waterproof structure for a mobile terminal device, which eliminates the need for a groove while using a waterproof gasket, and thus reduces unnecessary space to enable miniaturization of the device. Waterproof structure 1 of mobile terminal device 10 includes exterior resin 5 extending between first casing 3 and second casing 4 that face each other and extending over the outer circumferences thereof, and waterproof gasket 6 formed along the inner circumference of exterior resin 5 to be integral with exterior resin 5, wherein waterproof gasket 6 is sandwiched and compressed between first casing 3 and second casing 4.

### TECHNICAL FIELD

The present invention relates to a waterproof structure and a waterproofing method for a mobile terminal device.

### BACKGROUND ART

Patent Literature 1 discloses a structure of a waterproof mobile wireless device including a first casing and a second casing that are fitted to each other. The first casing has a groove formed entirely on a fitting surface thereof to which the second casing is fitted, and an insertion portion of a waterproof gasket is mounted in the groove when the first casing and the second casing are fitted to each other. The waterproof gasket has a belt portion connected to the insertion portion so as to seal an outer circumference of fitting potions of the first casing and the second casing.

FIGS. 1A to 1C show a waterproof structure of a mobile terminal device in the related art. FIG. 1A is a perspective view showing mobile terminal device 110. FIG. 1B is a sectional view taken along line A-A of mobile terminal device 110 shown in FIG. 1A. To obtain a structure that is waterproof, waterproof gasket 106 and grooved component 109, into which waterproof gasket 106 is fitted, are provided. The waterproof structure thus created is sandwiched between first casing 103 and second casing 104. Grooved component 109 is supported on base plate 121. FIG. 1C is a schematic diagram showing a square region enclosed by a thick line of FIG. 1B. How waterproof gasket 106 is fitted into grooved component 109 is clearly shown.

### CITATION LIST

### Patent Literature

Patent Literature 1: JP 10-70375 A

### SUMMARY OF INVENTION

### Technical Problem

The development of a waterproof mobile terminal device requires further miniaturization of the waterproof structure in order to reduce the size of the terminal device. In the structure of the waterproof mobile terminal device described in Patent Literature 1, the groove into which the waterproof gasket is fitted is required, and space needed for the groove inhibits miniaturization of the device.

Also, in the waterproof structure of the mobile terminal device in the related art shown in FIGS. 1A to 1C, grooved component 109 into which waterproof gasket 106 is fitted is required, and thus it is difficult to reduce space needed for grooved component 109. Besides, as can be seen in FIG. 1B, the space needed for grooved component 109 is very large.

It is therefore an object of the present invention to provide a waterproof structure and a waterproofing method for a mobile terminal device, which eliminate the need for a groove while using a waterproof gasket, and thus reduces unnecessary space to enable miniaturization of the device.

### Solution to Problem

The waterproof structure of a mobile terminal device according to the present invention includes an exterior resin extending between a first casing and a second casing that face each other and extending over outer circumferences thereof, and a waterproof gasket formed along an inner circumference of the exterior resin to be integral with the exterior resin, wherein the waterproof gasket is sandwiched and compressed between the first casing and the second casing.

The waterproofing method of a mobile terminal device according to the present invention includes the steps of providing an exterior resin extending between a first casing and a second casing that face each other and extending over outer circumferences thereof, providing a waterproof gasket formed along an inner circumference of the exterior resin to be integral with the exterior resin, and sandwiching and compressing the waterproof gasket between the first casing and the second casing to realize a waterproof structure.

### Advantageous Effects of Invention

The present invention can provide a waterproof structure and a waterproofing method for a mobile terminal device, which eliminate the need for a groove while using a waterproof gasket, and thus reduces unnecessary space to enable miniaturization of a device.

### BRIEF DESCRIPTION OF DRAWINGS

FIG. 1A is a perspective view showing a mobile terminal device related to the present invention;

FIG. 1B is a sectional view showing the mobile terminal device related to the present invention;

FIG. 1C is a schematic diagram showing a square region enclosed by a thick line of FIG. 1B;

FIG. 2 is a perspective view showing an overall configuration of a waterproof structure of a mobile terminal device according to a first embodiment of the present invention;

FIG. 3 is a perspective view showing an overall configuration of a waterproof structure of a mobile terminal device according to a second embodiment of the present invention;

FIG. 4A is a perspective view showing a waterproof gasket integrated with an exterior resin according to the second embodiment of the present invention;

FIG. 4B is a sectional view showing the waterproof gasket integrated with the exterior resin according to the second embodiment of the present invention;

FIG. 5A is a perspective view showing the mobile terminal device according to the second embodiment of the present invention;

FIG. 5B is a sectional view showing the mobile terminal device according to the second embodiment of the present invention;

FIG. 6A is a perspective view showing the mobile terminal device according to the second embodiment of the present invention;

FIG. 6B is a sectional view showing the mobile terminal device according to the second embodiment of the present invention;

FIG. 7A is a perspective view showing the mobile terminal device according to the second embodiment of the present invention;

FIG. 7B is a sectional view showing the mobile terminal device according to the second embodiment of the present invention;

FIG. 8A is a perspective view showing a mobile terminal device related to the second embodiment of the present invention; and

FIG. 8B is a sectional view showing the mobile terminal device related to the second embodiment of the present invention.

### REFERENCE SIGNS LIST

1 Waterproof structure

3 First casing

4 Second casing

5 Exterior resin

6 Waterproof gasket

7 Side key

8 Screw

10 Mobile terminal device

13 Pair of resin members

14 Pair of gasket members

15 Waterproof gasket film

16 Opening

18 Surface of first casing side

19 Surface of second casing side

20 Surface facing casing inside

### DESCRIPTION OF EMBODIMENTS

Hereinafter, embodiments of the present invention will be described in detail with reference to the drawings.

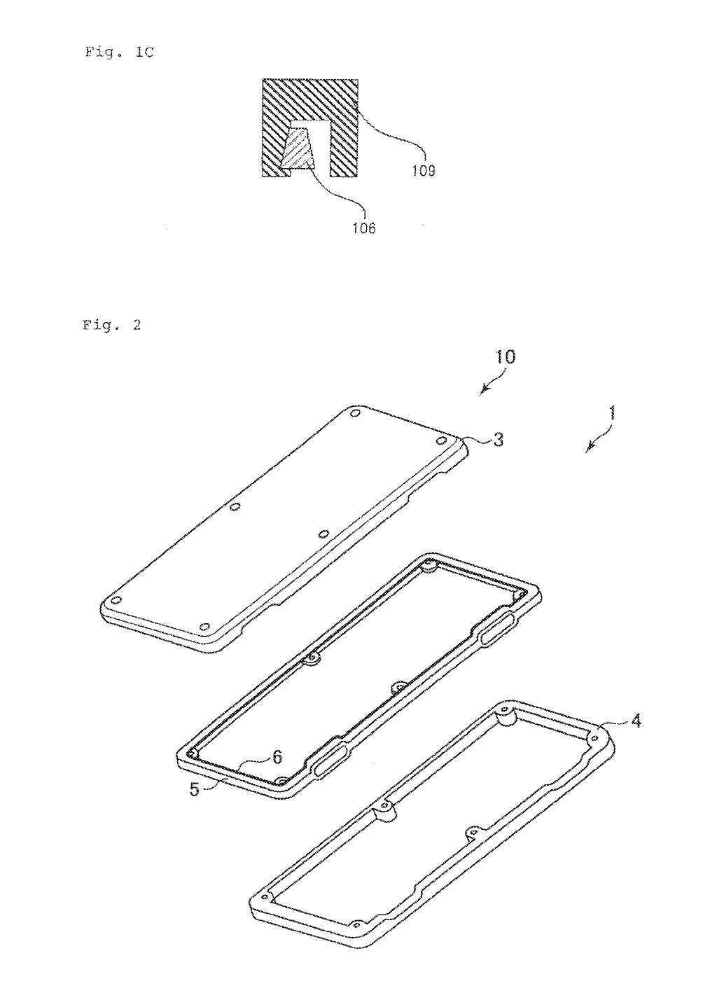

FIG. 2 is a perspective view showing an overall configuration of waterproof structure 1 of mobile terminal device 10 according to a first embodiment of the present invention. Waterproof structure 1 mainly includes waterproof gasket 6 integrated with exterior resin 5. Exterior resin 5 extends between first casing 3 and second casing 4 that face each other and extends over outer circumferences thereof, and waterproof gasket 6 extends along the inside of exterior resin 5. Waterproof gasket 6 is sandwiched and compressed between first casing 3 and second casing 4.

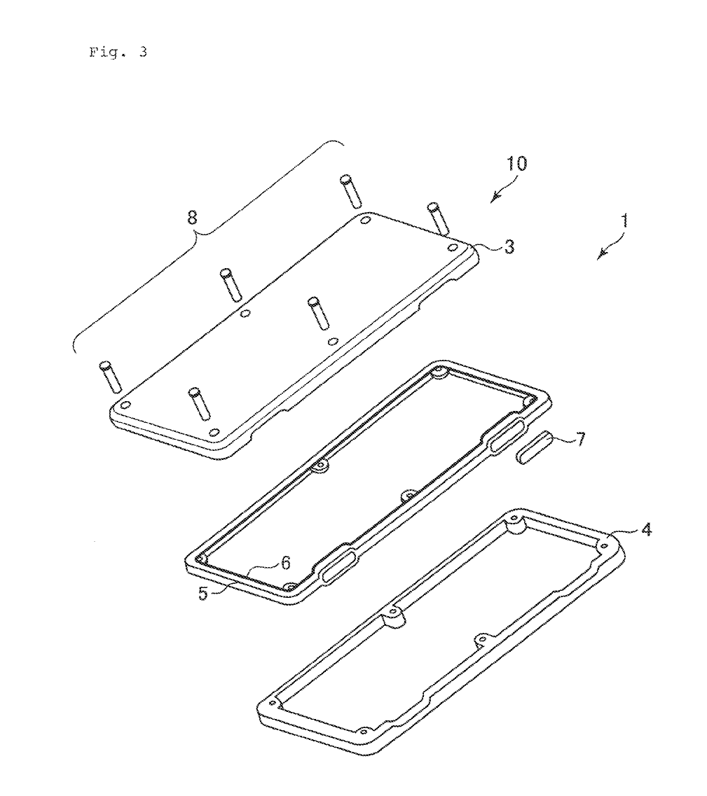

FIGS. 3 to 7B show mobile terminal device 10 according to a second embodiment of the present invention.

FIG. 3 is a perspective view showing an overall configuration of waterproof structure 1 of mobile terminal device 10. Waterproof structure 1 mainly includes waterproof gasket 6 integrated with exterior resin 5. Exterior resin 5 extends between first casing 3 and second casing 4 that face each other and extends over outer circumferences thereof, and waterproof gasket 6 extends along the inside of exterior resin 5. Waterproof gasket 6 is made of a silicone resin. Waterproof gasket 6 is insert-molded to be integral with exterior resin 5. The insert molding represents one of the methods for resin molding. With this method, after a mold is loaded with an insert article that is to be buried, a resin is injected into a molding machine, and then the molten resin wraps the insert article to be solidified, thereby creating a composite component that integrates the insert article with the resin. In this case, after the mold is loaded with exterior resin 5 which is an insert article, the melt of a silicone resin which is the material of waterproof gasket 6 is injected into the molding machine. Thus, the melt of the silicone resin wraps exterior resin 5 to be solidified, and a composite component that integrates waterproof gasket 6 with exterior resin 5 is created. Mobile terminal device 10 is formed by sandwiching waterproof gasket 6, integrated with exterior resin 5, between first casing 3 and second casing 4 and fixing it by a plurality of screws 8. On a side face of mobile terminal device 10, one or more side input/output portions 7 are provided.

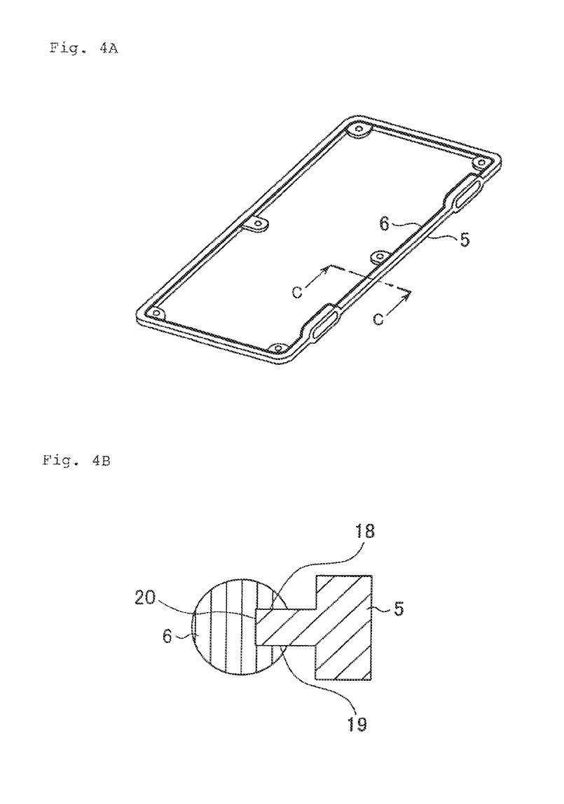

FIGS. 4A and 4B show waterproof gasket 6 integrated with exterior resin 5. FIG. 4A is a perspective view showing waterproof gasket 6 integrated with exterior resin 5, and FIG. 4B is a sectional view taken along line C-C shown in FIG. 4A. The C-C sectional view is a sectional view of a general region excluding side input/output portions 7 arranged in mobile terminal device 10 and a screw fixing portion including screws 8 for screwing first casing 3 and second casing 4. When viewed in FIG. 4B, exterior resin 5 has a convex shape toward the casing inside, and waterproof gasket 6 has a circular shape. Waterproof gasket 6 is insert-molded in exterior resin 5, and thus the section of waterproof gasket 6 is shaped to surround the section of exterior resin 5. In other words, at a joint region between exterior resin 5 and waterproof gasket 6, waterproof gasket 6 is in contact with exterior resin 5 on all of surface 18 of the first casing side of exterior resin 5, surface 19 of the second casing side, and surface 20 facing the casing inside.

In contrast to the example shown in FIG. 4B, the section of exterior resin 5 may not always be convex. For example, it may be triangular, trapezoidal, or rectangular. Similarly, the section of waterproof gasket 6 may not always be circular. For example, it may be elliptical, rectangular, trapezoidal, or triangular.

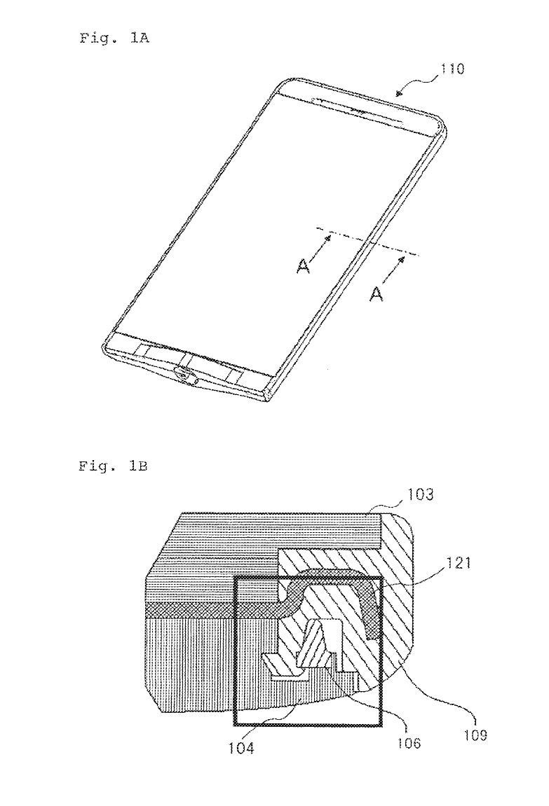

The use of waterproof gasket 6, integrated with exterior resin 5, as shown in FIGS. 4A and 4B, makes it unnecessary to use a grooved component (corresponding to 109 shown in FIGS. 1B and 1C) into which waterproof gasket 6 can be fitted, thereby eliminate the need for space for the grooved component. As a result, the size of the waterproof structure can be reduced, thus enabling miniaturization of the mobile terminal device.

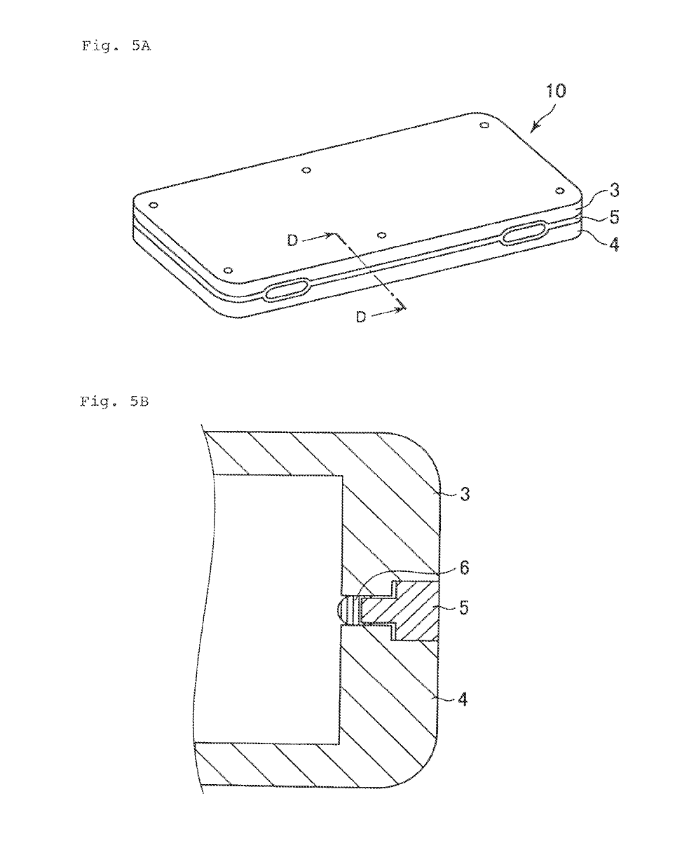

FIG. 5A is a perspective view showing mobile terminal device 10, and FIG. 5B is a sectional view taken along line D-D shown in FIG. 5A. As in the case of the C-C sectional view of FIG. 4B, the D-D sectional view is a sectional view of a general region excluding side input/output portions 7 and the screw fixing portion. A structure that is waterproof is obtained by sandwiching and compressing waterproof gasket 6, integrated with exterior resin 5, between first casing 3 and second casing 4. This can be seen in FIG. 5B in which waterproof gasket 6 that had a circular shape as shown in FIG. 4B is deformed by mounting first casing and second casing 4 to waterproof gasket 6 integrated with exterior resin 5.

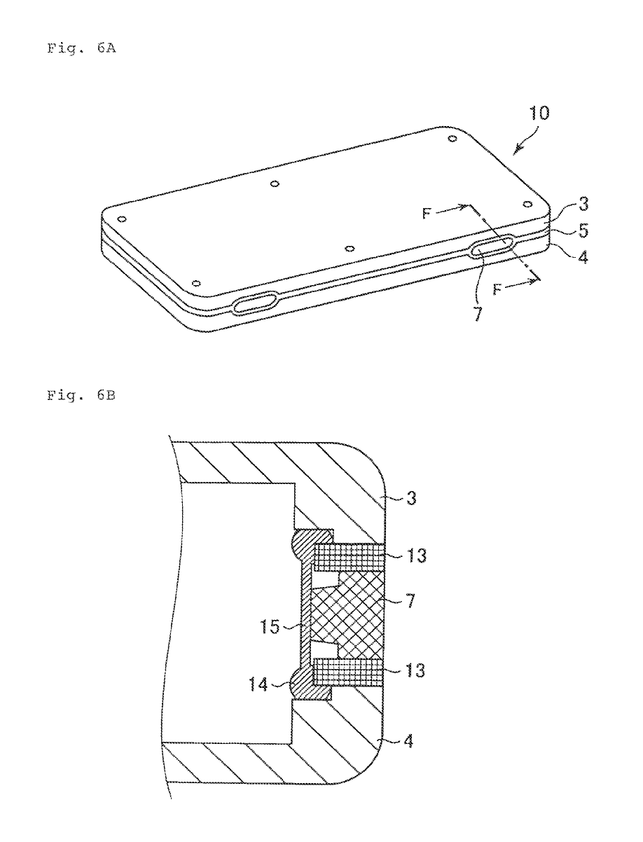

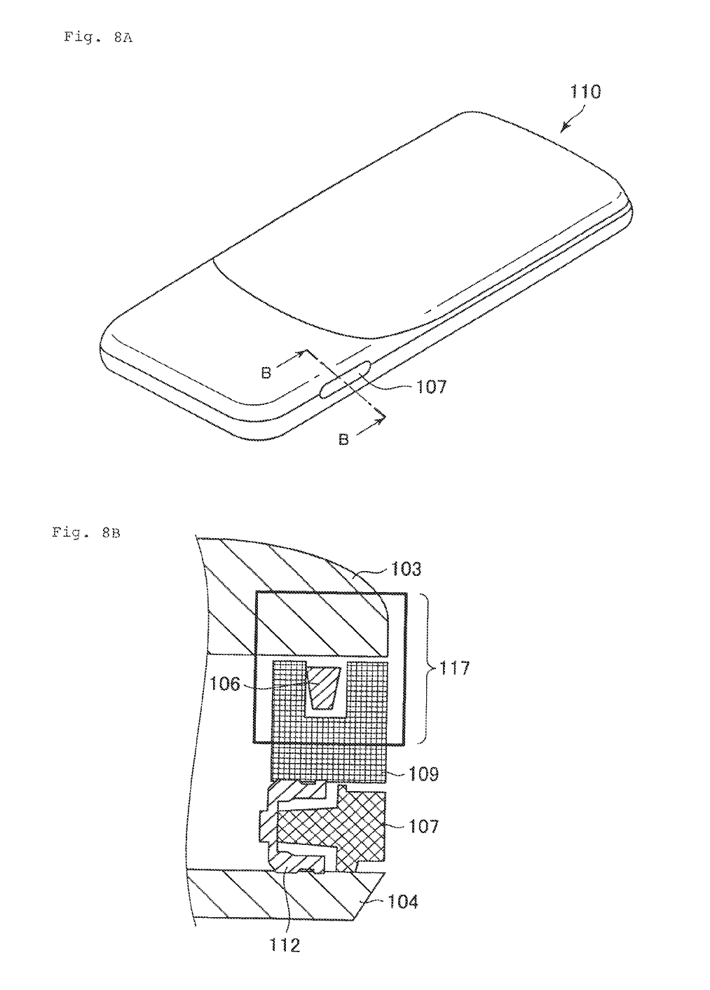

FIG. 6A is a perspective view showing mobile terminal device 10, and FIG. 6B is a sectional view taken along line F-F shown in FIG. 6A. The F-F sectional view is a sectional view at side input/output portion 7. Examples of the side input/output portions include a side key, a side USB terminal, a side disk slot, and a side power button. In this case, an example of side key 7 is shown. FIGS. 8A and 8B show a waterproof structure at side key 107 in the related art. FIG. 8A is a perspective view showing mobile terminal device 110, and FIG. 8B is a sectional view taken along line B-B shown in FIG. 8A. The B-B sectional view is a sectional view at the side key portion. The waterproof structure is sandwiched between first casing 103 and second casing 104. As can be seen in FIG. 8B, at the side key portion, in addition to waterproof gasket 106 that is fitted into groove 109 in exterior case waterproof structure 117 as indicated by a square region enclosed by a thick line, another component, i.e., waterproof gasket 112, must be used. According to the present invention, as can be seen in FIG. 4A or FIG. 6A, exterior resin 5 has, at side key 7, a pair of resin members 13 divided into two portions, i.e., first casing 3 side and second casing 4 side, to house side key 7. Waterproof gasket 6 has a pair of gasket members 14 formed along the inner circumference of exterior resin 5 by insert-molding to be integral with the pair of resin members 13. Waterproof gasket film 15 is provided to be located between the pair of gasket members 14 and to spatially separate the side key portion from the casing inside. Waterproof gasket film 15 is formed together with the pair of gasket members 14 by insert-molding. The pair of gasket members 14 and waterproof gasket film 15 are both made of a silicone resin. When viewed in FIG. 6B, the pair of resin members 13 has a rectangular section. The pair of gasket members 14 is formed by insert-molding to be integral with the pair of resin members 13, and thus the section of the pair of gasket members 14 has a shape that surrounds the section of the pair of resin members 13 and that forms a part of a deformed circular shape. The circular shape is deformed because the pair of gasket members 14 is sandwiched and compressed between first casing 3 and second casing 4, which contributes to a structure that is waterproof. By providing waterproof gasket film 15, the side key portion is spatially separated completely from the casing inside, thereby obtaining a structure that is highly waterproof.

This waterproof structure makes it unnecessary to use another component, i.e., waterproof gasket 12, at the side key portion. This is very advantageous in that a reduction in development costs is achieved by reducing the numbers of components and assembling steps.

In contrast to the example shown in FIG. 6B, the section of the pair of resin members 13 may not always be rectangular. For example, it may be trapezoidal or triangular. Similarly, the section of the pair of gasket members 14 may not always be circular. For example, it may be elliptical, rectangular, or triangular.

In the sectional view of FIG. 6B, the structure is horizontally symmetrical. This is because of the equal sizes of first casing 3 and second casing 4 in this embodiment. Generally, first casing 3 and second casing 4 have different sizes. In such a case, the pair of resin members 13, the pair of gasket memes 14, and waterproof gasket film 15 have a horizontally asymmetrical structure.

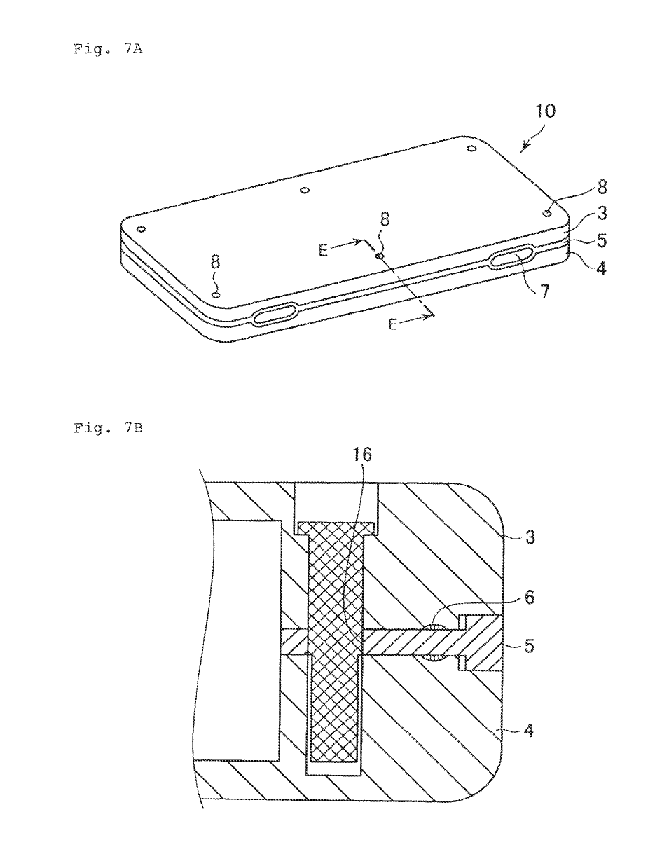

FIG. 7A is a perspective view showing mobile terminal device 10, and FIG. 7B is a sectional view taken along line E-E shown in FIG. 7A. The E-E sectional view is a sectional view at the screw fixing portion for screwing first casing 3 and second casing 4 of mobile terminal device 10. As can be seen in FIG. 7B, exterior resin 5 has opening 16 for receiving screw 8, and screw 8 is vertically inserted into the casings, specifically, from first casing 3 to second casing 4. Screw 8 penetrates almost entirely through mobile terminal device 10 from the rear to the front thereof. Exterior resin 5 extends inside enough to be provided with opening 16 to receive screw 8. Waterproof gasket 6 is located between an outer circumference portion of exterior resin 5 and opening 16. In FIG. 7B, waterproof gasket 6 is drawn substantially circular to facilitate identification of the position of waterproof gasket 6. In reality, however, waterproof gasket 6 is deformed by first casing 3 and second casing 4. A structure that is waterproof is obtained by sandwiching and compressing waterproof gasket 6 between first casing 3 and second casing 4.

In this embodiment, waterproof gasket 6, the pair of gasket members 14, and gasket film 15 are made of a silicone resin, but may be made of elastomer.

The present invention can be applied to a mobile terminal device, in particular, a mobile phone, a PHS (Personal Handyphone System), or a PDA (Personal Data Assistance or Personal Digital Assistant).

While the present invention has been described with reference to the embodiments, the present invention is not limited to the embodiments described above. It will be understood by those skilled in the art that various changes in form and details may be made therein without departing from the scope of the present invention.

The present application is based upon and claims the benefit of priority from Japanese Patent Application No. 2011-180402 filed on Aug. 22, 2011, the disclosure of which is incorporated herein in its entirety by reference.

1. A waterproof structure of a mobile terminal device comprising:
an exterior resin extending between a first casing and a second casing that face each other and extending over outer circumferences thereof; and
a waterproof gasket formed along an inner circumference of the exterior resin to be integral with the exterior resin,
wherein the waterproof gasket is sandwiched and compressed between the first casing and the second casing.

2. The waterproof structure of the mobile terminal device according to claim 1, wherein:
the exterior resin includes, at a side input/output portion provided on a side face portion of the mobile terminal device, a pair of resin members divided into the first casing side and the second casing side to house the side input/output portion;
the waterproof gasket includes a pair of gasket members formed along the inner circumference of the exterior resin to be integral with the pair of resin members; and
a waterproof gasket film is provided to be located between the pair of gasket members and to spatially separate the side input/output portion from casing insides.

3. The waterproof structure of the mobile terminal device according to claim 1, wherein:
the exterior resin includes, at a screw fixing portion for screwing the first casing and the second casing of the mobile terminal device, an opening for receiving a screw; and
the waterproof gasket is located between an outer circumference portion and the opening of the exterior resin.

4. The waterproof structure of the mobile terminal device according to claim 1, wherein the waterproof gasket is made of a silicone resin.

5. The waterproof structure of the mobile terminal device according to claim 1, wherein the waterproof gasket is made of elastomer.

6. A mobile terminal device having the waterproof structure of the mobile terminal device according to claim 1.

7. A waterproofing method of a mobile terminal device comprising the steps of:
providing an exterior resin extending between a first casing and a second casing that face each other and extending over outer circumferences thereof;
providing a waterproof gasket formed along an inner circumference of the exterior resin to be integral with the exterior resin; and
sandwiching and compressing the waterproof gasket between the first casing and the second casing to realize a waterproof structure.
